(19) United States
(12) Patent Application Publication
(10) Pub. No.: US 2012/0056909 A1
(43) Pub. Date: Mar. 8, 2012

(54) DRIVING METHOD OF DISPLAY PANEL

(75) Inventors: Ming-Chia Shih, Miao-Li County (TW); Fu-Chi Yang, Miao-Li County (TW); Yueh-Jui Li, Miao-Li County (TW)

(73) Assignee: CHIMEI INNOLUX CORPORATION STSP BRANCH, Miao-Li County (TW)

(21) Appl. No.: 13/210,799

(22) Filed: Aug. 16, 2011

(30) Foreign Application Priority Data
Sep. 8, 2010 (TW) 99130385

(51) Int. Cl. G09G 5/10; G06F 3/038

(52) U.S. Cl. 345/690; 345/204

(57) ABSTRACT

A driving method for a display panel is provided, wherein the display panel includes a plurality of scan lines, data lines and pixels. The driving method includes the step of driving N scan lines simultaneously and delivering the same pixel data to the pixels coupled to the enabled N scan lines through each one data line. N is a positive integral, and N>1.

### CROSS-REFERENCE TO RELATED APPLICATION

This application claims the priority benefit of Taiwan application serial no. 99130385, filed on Sep. 8, 2010. The entirety of the above-mentioned patent application is hereby incorporated by reference herein and made a part of this specification.

### BACKGROUND OF THE INVENTION

1. Field of the Invention

The invention relates to a driving method of a display panel. Particularly, the invention relates to a driving method of a display panel capable of mitigating a motion blur phenomenon.

2. Description of Related Art

With quick development of technology, in development of display techniques, besides features of lightness, slimness, shortness and smallness of a display device are continually pursued, display of three-dimensional (3D) images is also required. Generally, a principle of displaying a 3D image is to respectively send two different images to a left eye and a right eye to construct a 3D image in the brain.

FIG. 1 is a schematic diagram of a conventional 3D display device, and FIG. 2 is a timing diagram of the 3D display device of FIG. 1 displaying 3D images. Referring to FIG. 1 and FIG. 2, it is assumed that frame data delivered by a computer 10 drives a display device 20 to update a single eye frame every a time period T, and a display panel 22 of the display device 20 completes updating a left eye frame within a time interval TA, shown by a timing line “Panel” of FIG. 2. Meanwhile, a backlight module 24 of the display device 20 is maintained in a full-time turn-on state, shown by a timing line “BLU” in FIG. 2. Since the frame displayed on the display panel 22 during the frame updating process time interval TA is not expected to be viewed by the user, a right lens 32 and a left lens 34 of a pair of glasses 30 are all in an opaque state within such 5.64 ms, so as to avoid the user wearing the glasses 30 from viewing the updating frame of the display panel 22, shown by the timing lines “R” and “L” in FIG. 2.

After the display panel 22 completes updating the left eye frame, the display panel 22 continually displays the updated left eye frame for a time interval TB. The backlight module 24 is still maintained to the full-time turn-on state to provide the backlight source. Moreover, the left lens 34 of the glasses 30 is switched to a light pervious state during the time interval TB, so that the left eye frame displayed by the display device 20 can be transmitted to the left eye of the user. The right lens 32 of the glasses 30 is maintained to the opaque state during the time interval TB, so as to prevent the left eye frame displayed by the display device 20 from reaching the right eye of the user.

By repeating a similar procedure, the display panel 22 completes updating a right eye frame during a next time interval TA, and continually displays the updated right eye frame for the time interval TB. The backlight module 24 is still maintained to the full-time turn-on state to provide the backlight source. The right lens 32 of the glasses 30 is maintained to the opaque state during the time interval TA, and is switched to the light pervious state during the time interval TB, so that the updated right eye frame displayed by the display device 20 can be transmitted to the right eye of the user. The left lens 34 of the glasses 30 is maintained to the opaque state during the time period T, so as to prevent the right eye frame displayed by the display device 20 from reaching the left eye of the user.

According to the above method, the user wearing the glasses 30 can view 3D images based on a visual persistence phenomenon.

However, since liquid crystal has a slow response speed, when the frame is updated during the time interval TA, a response time available for the liquid crystal on the scan lines that are enabled later in the display panel 22 is relatively short, so that the user may probably view a previous frame, which is the so called motion blur phenomenon. FIG. 3 is a diagram illustrating relationships between the scan line enable time and the liquid crystal response time. The time for a first, an (N/2)^{th} and an N^{th} scan lines waiting to be enabled by a scan pulse signal P1 is respectively t0, t1 and t2 (t2>t1>t0), and available response time lengths thereof are respectively TR0, TR1 and TR2. According to FIG. 3, it is obvious that the later the scan line is enabled, the shorter the available response time thereof is, which makes the liquid crystal harder to be rotated to required positions before entering the time interval TB. Therefore, the presented transmittance is incorrect, and the display panel 22 may have the motion blur phenomenon.

### SUMMARY OF THE INVENTION

The invention is directed to a driving method of a display panel, which can mitigate a motion blur phenomenon of the display panel.

The invention provides a driving method of a display panel. The display panel includes a plurality of scan lines, a plurality of data lines and a plurality of pixels. The driving method of the display panel includes simultaneously enabling N scan lines and delivering same pixel data to the pixels coupled to the enabled N scan lines through each of the data lines, where N is a positive integer greater than 1.

In an embodiment of the invention, the driving method of the display panel includes following steps. N scan lines are simultaneously enabled during each of a plurality of first scan periods, and the same pixel data is delivered to the pixels coupled to the N scan lines through each of the data lines, so as to sequentially enable all of the scan lines to update a display frame of the display panel, where the pixel data delivered by odd data lines is obtained by sampling pixel data corresponding to odd pixels on odd scan lines, and the pixel data delivered by even data lines is obtained by sampling pixel data corresponding to even pixels on even scan lines. Then, the display frame updated during the first scan periods is held during a first frame holding period.

In an embodiment of the invention, the driving method of the display panel includes following steps. N scan lines are simultaneously enabled during each of a plurality of second scan periods after the first frame holding period, and the same pixel data is delivered to the pixels coupled to the N scan lines through each of the data lines, so as to sequentially enable all of the scan lines to update a display frame of the display panel, where the pixel data delivered by the odd data lines is obtained by sampling pixel data corresponding to the odd pixels on the even scan lines, and the pixel data delivered by the even data lines is obtained by sampling pixel data corresponding to the even pixels on the odd scan lines. Then, the display frame updated during the second scan periods is held during a second frame holding period.

In an embodiment of the invention, the pixel data delivered by each of the data lines is a weighted average obtained by performing a weighted operation on the pixel data of the sampled pixels and the adjacent pixels thereof

In an embodiment of the invention, the weighted operation is performed on gray scale values or brightness values of the pixel data.

In an embodiment of the invention, the pixel data delivered by each of the data lines is a weighted average obtained by performing a weighted operation on the pixel data of the sampled pixels and four adjacent pixels thereof

In an embodiment of the invention, the pixel data delivered by each of the data lines is a weighted average obtained by performing a weighted operation on the pixel data of the sampled pixels and eight adjacent pixels thereof.

In an embodiment of the invention, the driving method of the display panel includes following steps. N scan lines are simultaneously enabled during each of a plurality of second scan periods after the first frame holding period, and the same pixel data is delivered to the pixels coupled to the N scan lines through each of the data lines, so as to sequentially enable all of the scan lines to update a display frame of the display panel, where the pixel data delivered by the odd data lines is obtained by sampling pixel data corresponding to the odd pixels on the odd scan lines, and the pixel data delivered by the even data lines is obtained by sampling pixel data corresponding to the even pixels on the even scan lines. Then, the display frame updated during the second scan periods is held during a second frame holding period.

In an embodiment of the invention, during the first scan periods, the scan lines are sequentially enabled from a first scan line in a unit of N scan lines, and during the second scan periods, the first scan line to a (P-1)^{th} scan line are first enabled, and then the remained scan lines are sequentially enabled from a p^{th} scan line in a unit of N scan lines, where P is a positive integer greater than 1.

In an embodiment of the invention, the driving method of the display panel includes following steps. N scan lines are simultaneously enabled during each of a plurality of third scan periods after the second frame holding period, and the same pixel data is delivered to the pixels coupled to the N scan lines through each of the data lines, so as to sequentially enable all of the scan lines to update a display frame of the display panel, where the pixel data delivered by the odd data lines is obtained by sampling pixel data corresponding to the odd pixels on the even scan lines, and the pixel data delivered by the even data lines is obtained by sampling pixel data corresponding to the even pixels on the odd scan lines. Then, the display frame updated during the third scan periods is held during a third frame holding period. Then, N scan lines are simultaneously enabled during each of a plurality of fourth scan periods after the third frame holding period, and the same pixel data is delivered to the pixels coupled to the N scan lines through each of the data lines, so as to sequentially enable all of the scan lines to update a display frame of the display panel, where the pixel data delivered by the odd data lines is obtained by sampling pixel data corresponding to the odd pixels on the even scan lines, and the pixel data delivered by the even data lines is obtained by sampling pixel data corresponding to the even pixels on the odd scan lines. Then, the display frame updated during the fourth scan periods is held during a fourth frame holding period.

In an embodiment of the invention, during the third scan periods, the first scan line to a (P-1)^{th} scan line are first enabled, and then the remained scan lines are sequentially enabled from a p^{th} scan line in a unit of N scan lines, and during the fourth scan periods, all scan lines are sequentially enabled from the first scan line in a unit of N scan lines.

In an embodiment of the invention, the driving method of the display panel includes following steps. N scan lines are simultaneously enabled during each of a plurality of first scan periods, and the same pixel data is delivered to the pixels coupled to the N scan lines through each of the data lines, so as to sequentially enable all of the scan lines to update a display frame of the display panel, where the pixel data delivered by each of the data lines is an average of the pixel data of the pixels corresponding to the same data line on the N enabled scan lines. Then, the display frame updated during the first scan periods is held during a first frame holding period.

In an embodiment of the invention, the average is an average of grayscale values or brightness values of the pixels.

In an embodiment of the invention, the driving method of the display panel includes following steps. N scan lines are simultaneously enabled during each of a plurality of first scan periods, and the same pixel data is delivered to the pixels coupled to the enabled N scan lines through each of the data lines, so as to sequentially enable all of the scan lines to update a display frame of the display panel, where during the first scan periods, all scan lines are sequentially enabled from a first scan line in a unit of N scan lines. Then, the display frame updated during the first scan periods is held during a first frame holding period. Then, N scan lines are simultaneously enabled during each of a plurality of second scan periods, and the same pixel data is delivered to the pixels coupled to the enabled N scan lines through each of the data lines, so as to sequentially enable all of the scan lines to update a display frame of the display panel, where during the second scan periods, the first scan line to a (P-1)^{th} scan line are first enabled, and then the remained scan lines are sequentially enabled from a p^{th} scan line in a unit of N scan lines, where P is a positive integer greater than 1. Then, the display frame updated during the second scan periods is held during a second frame holding period.

According to the above descriptions, the time required for updating the display frame is shortened by simultaneously enabling a plurality of the scan lines, so that the liquid crystal has enough time for rotating to the required positions to avoid the motion blur phenomenon of the display panel.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional three-dimensional (3D) display device.

FIG. 2 is a timing diagram of the 3D display device of FIG. 1 displaying 3D images.

FIG. 3 is a diagram illustrating relationships between scan line enable time and liquid crystal response time.

FIG. 4 is a flowchart illustrating a driving method of a display panel according to an embodiment of the invention.

FIG. 5 is a driving schematic diagram of a display panel according to an embodiment of the invention.

FIG. 6 is a timing diagram of a display panel displaying a frame.

FIG. 7 is a driving schematic diagram of a display panel according to another embodiment of the invention.

FIG. 8 is a driving schematic diagram of a display panel according to another embodiment of the invention.

FIG. 9 is a driving schematic diagram of a display panel according to another embodiment of the invention.

FIG. 10 is a driving schematic diagram of a display panel according to another embodiment of the invention.

FIG. 11 is a driving schematic diagram of a display panel according to another embodiment of the invention.

FIG. 12 is a driving schematic diagram of a display panel according to another embodiment of the invention.

FIG. 13A is a schematic diagram of a sampling method of pixel data according to an embodiment of the invention.

FIG. 13B is a schematic diagram of a sampling method of pixel data according to another embodiment of the invention.

FIG. 14 is a driving schematic diagram of a display panel according to another embodiment of the invention.

FIG. 15 is a driving schematic diagram of a display panel according to an embodiment of the invention.

FIG. 16 is a driving schematic diagram of a display panel of a 2D2G structure according to an embodiment of the invention.

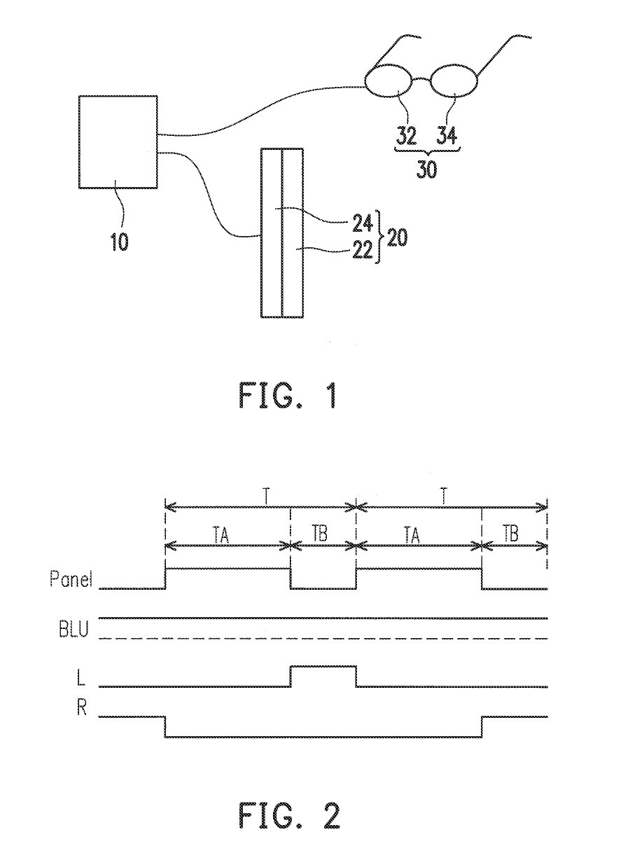

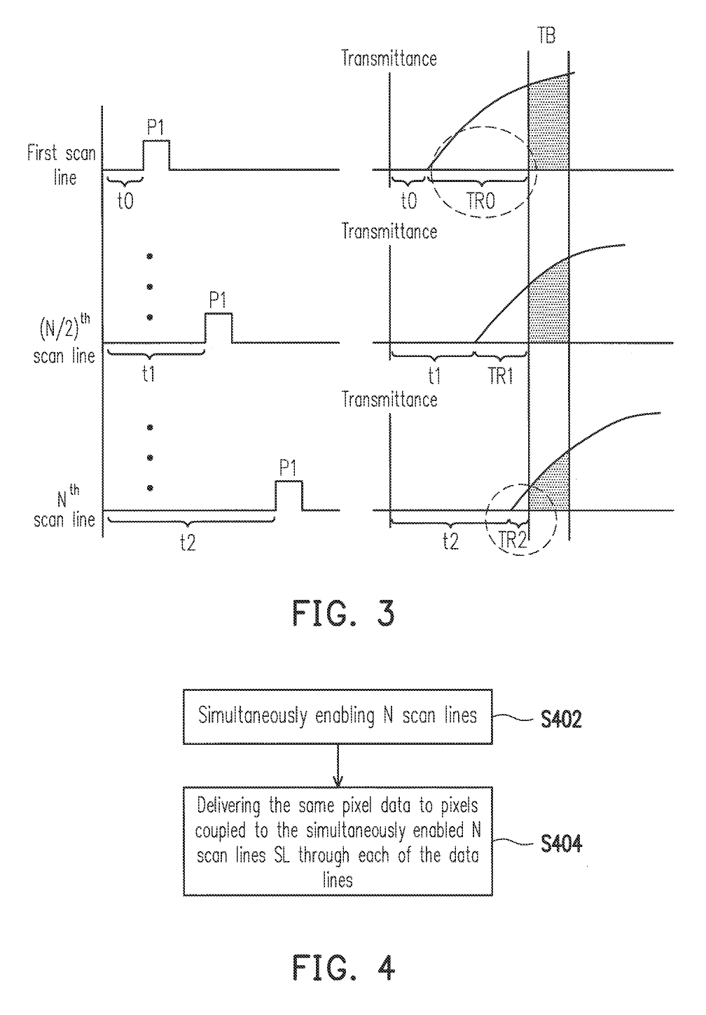

### DETAILED DESCRIPTION OF DISCLOSED EMBODIMENTS

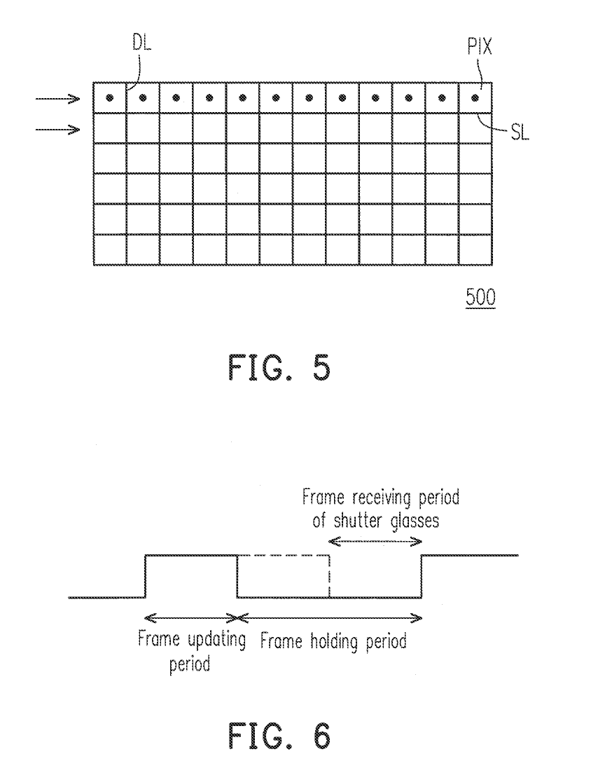

FIG. 4 is a flowchart illustrating a driving method of a display panel according to an embodiment of the invention. FIG. 5 is a driving schematic diagram of a display panel according to an embodiment of the invention. Referring to FIG. 4 and FIG. 5, a display panel 500 includes a plurality of scan lines SL, a plurality of data lines DL and a plurality of pixels PIX. The driving method of the display panel 500 includes following steps. First, in step S402, N scan lines SL on the display panel 500 are simultaneously enabled during a scan period, where N is a positive integer greater than 1, for example, N=2. Moreover, in step S404, the same pixel data is delivered to the pixels PIX coupled to the simultaneously enabled N scan lines SL through each of the data lines DL. As shown in FIG. 5, the pixel data transmitted by each of the data lines DL is the pixel data of the pixel PIX corresponding to each of the data lines DL on a first scan line SL of the enabled two scan lines SL. Namely, in the scan period, the pixels PIX corresponding to the same data line DL on the two scan lines SL has the same gray scale value or brightness value (i.e. the same pixel data).

By sequentially repeating the steps S402 and S404, after a plurality of the scan periods, the pixel data of all of the pixels PIX on the display panel 500 are updated, i.e. a display frame of the display panel 500 is updated, and then a frame holding period is entered to hold the updated display frame. After the frame holding period is ended, the frame updating steps of S402 and S404 are continually executed, and the display panel 500 displays a next updated frame during a next frame holding period. When the display panel 500 is applied for three-dimensional (3D) display, a right eye frame and a left eye frame are displayed at the adjacent frame holding periods, and a user can receive the adjacent holding frames through a pair of shutter glasses, so as to achieve a 3D display effect.

FIG. 6 is a timing diagram of a display panel displaying a frame. Referring to FIG. 6, when the driving method of the embodiment of FIG. 4 is used to drive the display panel 500, by simultaneously driving two scan lines SL, a time required for updating a frame is greatly reduced. A dot line part of FIG. 6 represents the time required for updating a frame of the display panel 500 during each scan period by only driving one scan line, and a solid line part represents the time required for updating a frame of the display panel 500 during each scan period by simultaneously driving two scan lines SL. According to FIG. 6, it is known that the time required for frame update by simultaneously driving two scan lines SL is only a half of the time required for frame update by only driving one scan line, i.e. the time required for frame update is reduced by a half In this way, the pixels PIX may have more response time, so that the shutter glasses may allow the display frame to pass there through after the liquid crystals of the pixels PIX are rotated to the required positions, so as to avoid a motion blur phenomenon.

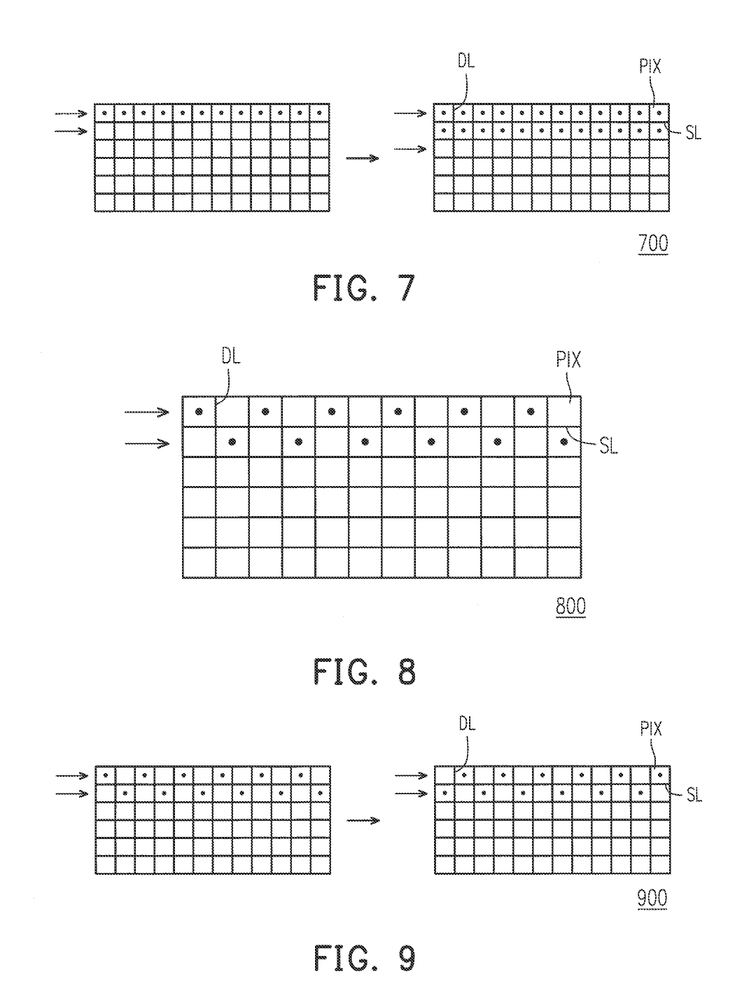

In the above embodiment, when the scan lines are enabled during frame updating periods of two adjacent display frames, it is all started from the first scan line in the display panel to simultaneously enable two scan lines, as that shown in FIG. 5. In other embodiment, during the frame updating period of one of the two adjacent display frames, it is started from the first scan line in the display panel to simultaneously enable the two scan lines SL, and during the next frame updating period, it is started from a p^{th} scan line to simultaneously enable the two scan lines SL, where P is a positive integer greater than 1. FIG. 7 is a driving schematic diagram of a display panel according to another embodiment of the invention. During the scan periods for updating the frame for the second time, it is started from the second scan line SL to sequentially enable the scan lines SL on the display panel 700 in a unit of two scan lines. It should be noticed that before the scan lines SL are sequentially enabled from the second scan line SL in the unit of two scan lines, the first scan line SL has to be first enabled, and then the remained scan lines SL are sequentially enabled in the unit of two scan lines, so as to maintain integrity of the display frame.

Moreover, in the above embodiment, although the pixel data of the pixel PIX corresponding to each of the data lines DL on the first scan line SL of the enabled two scan lines SL is sampled to serve as the driving data of the pixels PIX on each of the data lines DL, the invention is not limited thereto, and the method of sampling the pixel data can be varied according to actual design requirements. For example, the pixel data of the pixel PIX corresponding to each of the data lines DL on the second scan line SL of the enabled two scan lines SL can be sampled to serve as the driving data of the pixels PIX on each of the data lines DL. Embodiments of different pixel data sampling methods are provided below for reference.

FIG. 8 is a driving schematic diagram of a display panel according to another embodiment of the invention. Referring to FIG. 8, a difference between the present embodiment and the embodiment of FIG. 5 is that the pixel data sampling method of the present embodiment is different to that of the embodiment of FIG. 5. When the first and the second scan lines SL are simultaneously enabled during a first scan period, the pixel data delivered by odd data lines DL is obtained by sampling pixel data corresponding to odd pixels PIX on the first scan line SL, and the pixel data delivered by even data lines DL is obtained by sampling pixel data corresponding to even pixels PIX on the second scan line SL.

In this way, all of the scan lines SL on the display panel 800 are sequentially enabled in a unit of two scan lines SL, and after the pixel data of all of the pixels PIX is updated, the frame holding period is entered to hold the updated display frame. Then, after the frame holding period is ended, the same pixel data sampling method and the same scan line driving sequence are used to update frames and display the updated frames. Based on such chessboard-like sampling method, evenness of the frame displayed by the display panel 800 is enhanced.

FIG. 9 is a driving schematic diagram of a display panel according to another embodiment of the invention. Referring to FIG. 9, a difference between the driving method of the display panel 900 of the present embodiment and that of the embodiment of FIG. 8 lies in different pixel data sampling methods of two adjacent display frames. In the present embodiment, the pixel data sampling method of one of the two adjacent display frames is the same to the pixel data sampling method of the embodiment of FIG. 8. The sampling method of another display frame is as follows. When the first and the second scan lines SL are simultaneously enabled during the first scan period, the pixel data delivered by odd data lines DL is obtained by sampling pixel data corresponding to odd pixels PIX on the second scan line SL, and the pixel data delivered by even data lines DL is obtained by sampling pixel data corresponding to even pixels PIX on the first scan line SL. By sampling the pixel data of the pixels PIX on the compensation positions, besides the frame evenness of the display panel 900 is enhanced, resolution of the display frame is also increased.

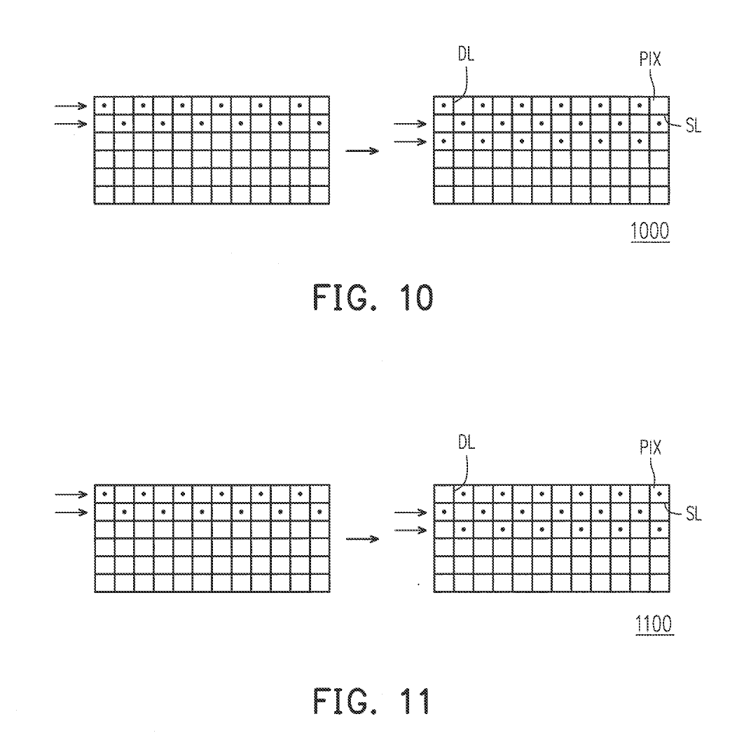

The driving method of the display panel of the embodiment of FIG. 8 can also be used in collaboration with the driving method of the display panel of the embodiment of FIG. 7 to change a start position for sequentially enabling the scan lines SL in the unit of two scan lines SL. FIG. 10 is a driving schematic diagram of a display panel 1000 according to an embodiment of the invention. Referring to FIG. 10, a difference between the present embodiment and the embodiment of FIG. 8 is that when the next frame update procedure is performed, it is started from the second scan line SL to sequentially enable the scan lines SL of the display panel 1000 in the unit of two scan lines. Similarly, before the scan lines SL of the display panel 1000 are sequentially enabled from the second scan line SL in the unit of two scan lines, the first scan line SL on the display panel 1000 has to be first enabled to maintain integrity of the display frame.

FIG. 11 is a driving schematic diagram of a display panel according to another embodiment of the invention. Referring to FIG. 11, a difference between the present embodiment and the driving method of the display panel of FIG. 10 is that in the next frame update procedure, when it is started from the second scan line SL to sequentially enable the scan lines SL of the display panel 1000 in the unit of two scan lines, a pixel data sampling position thereof is different to that of the embodiment of FIG. 10. In the present embodiment, when N scan lines SL are simultaneously enabled during the scan period, the pixel data delivered by the odd data lines DL is obtained by sampling pixel data corresponding to the odd pixels PIX on the even scan lines SL, and the pixel data delivered by the even data lines DL is obtained by sampling pixel data corresponding to the even pixels PIX on the odd scan lines SL. As shown in FIG. 11, when the second and the third scan lines SL are simultaneously enabled, the pixel data delivered by the odd data lines DL is obtained by sampling pixel data corresponding to the odd pixels PIX on the second scan lines SL, and the pixel data delivered by the even data lines DL is obtained by sampling pixel data corresponding to the even pixels PIX on the third scan lines SL.

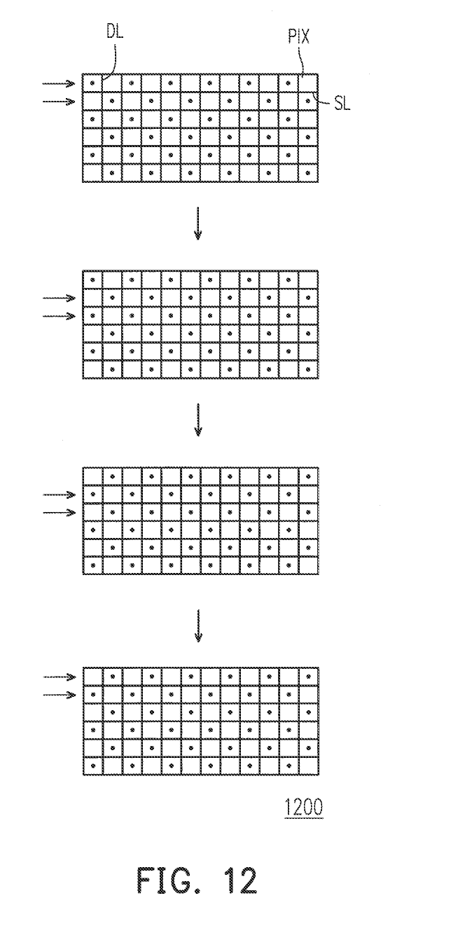

FIG. 12 is a driving schematic diagram of a display panel according to another embodiment of the invention. Referring to FIG. 12, the driving method of the display panel of the present embodiment is a combination of the driving methods of the embodiments of FIG. 9 and FIG. 10. First, according to the driving method of the embodiment of FIG. 10, during the scan periods of frame update for the second time, a position of the scan line started to sequentially enable the scan lines SL in the unit of two scan lines SL is postponed by one scan line, i.e. it is started from the second scan line SL to sequentially enable the scan lines SL of the display panel 1200 in the unit of two scan lines. Then, according to the driving method of FIG. 9, during the scan periods of frame update for the third time, the position of the scan line started to sequentially enable the scan lines SL in the unit of two scan lines SL is not changed, i.e. it is also started from the second scan line SL to sequentially enable the scan lines SL in the unit of two scan lines, though the pixel data sampling position is changed, so that the sampling position of the third frame update and the sampling position of the second frame update are complementary. Then, during the scan periods of frame update for the fourth time, the driving method of the embodiment of FIG. 10 is used, by which the position of the scan line started to sequentially enable the scan lines SL in the unit of two scan lines SL is changed, and the position of the scan line started to sequentially enable the scan lines SL in the unit of two scan lines SL is brought forward to the first scan line SL. By repeatedly using the driving methods of the embodiments of FIG. 9 and FIG. 10, the display frame may have better evenness and resolution.

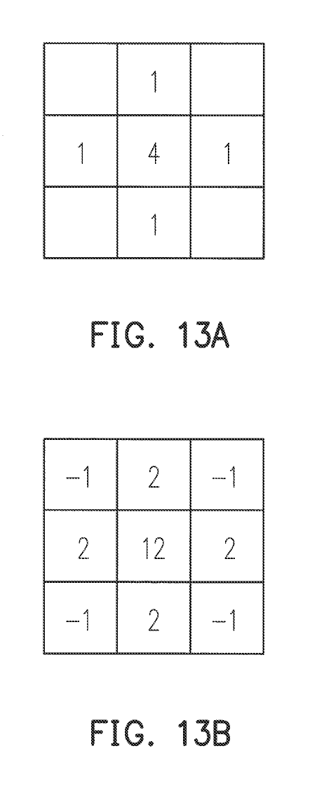

In the above embodiments, the sampling methods of the pixel data of the pixels PIX are all to directly sample the pixel values or gray scale values corresponding to the pixels PIX, though in some embodiments, a weighted operation can be performed on the pixel data of the pixel PIX to be sampled and the pixel data of the adjacent pixels thereof to obtain a weighted average to serve as the sampled pixel data. For example, FIG. 13A is a schematic diagram of a sampling method of pixel data according to an embodiment of the invention. In a pixel nine-square grid of FIG. 13A, each grid represents a pixel PIX, and it is assumed that the pixel PIX to be sampled (i.e. a target sampling pixel) is located at the center of the nine-square grid, and a number on each grid represents a weighted value of the pixel participating the weighted operation. In the sampling method of the pixel data of the present embodiment, a gray scale value (or a brightness value) of the target sampling pixel is multiplied by a corresponding weighted value 4, and gray scale values (or brightness values) of the pixels adjacent to the target sampling pixels are respectively multiplied by a corresponding weighted value (the weighted values are all 1), and then the calculated gray scale values (or the brightness values) are added, and finally an adding result thereof is divided by a sum of the weighted values of the 5 pixels PIX participating the weighted operation (a value thereof is 8) to obtained the weighted pixel data.

FIG. 13B is a schematic diagram of a sampling method of pixel data according to another embodiment of the invention. Referring to FIG. 13B, a difference between the present embodiment and the embodiment of FIG. 13A is that the number of the pixels PIX participating the weighted operation is 9, which include the target sampling pixel and 8 adjacent pixels. Similarly, In the sampling method of the pixel data of the present embodiment, a gray scale value (or a brightness value) of the target sampling pixel is multiplied by a corresponding weighted value 12, and gray scale values (or brightness values) of the 8 pixels adjacent to the target sampling pixels are respectively multiplied by a corresponding weighted value, and then the calculated gray scale values (or the brightness values) are added, and finally an adding result thereof is divided by a sum of the weighted values of the 9 pixels PIX participating the weighted operation to obtained the weighted pixel data.

In the embodiments of FIG. 13A and FIG. 13B, the weighted operation is performed on the pixel data of the pixel PIX to be sampled and the pixel data of the adjacent pixels thereof to obtain the weighted average to serve as the sampled pixel data, by which the evenness of the display frame can be further improved.

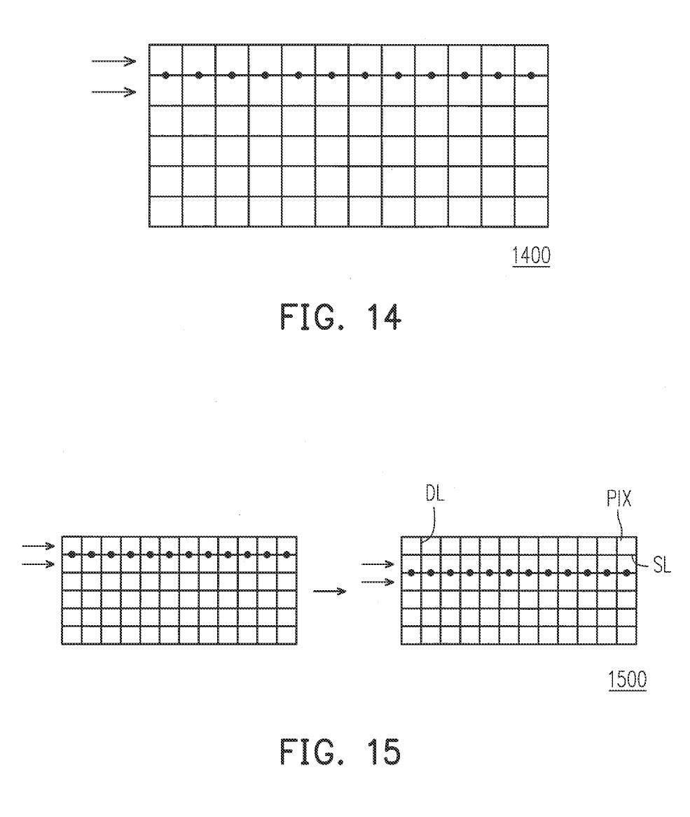

FIG. 14 is a driving schematic diagram of a display panel according to another embodiment of the invention. Referring to FIG. 14, a difference between the driving method of the display panel of the present embodiment and that of the embodiment of FIG. 5 is that in the pixel data sampling method of the present embodiment, when the N scan lines SL are simultaneously enabled during the scan period, the pixel data delivered by each of the data lines DL is an average of the pixel data of the pixels PIX corresponding to the same data line DL on the N enabled scan lines SL. As shown in FIG. 14, when the first and the second scan lines SL are simultaneously enabled, the pixel data delivered by each of the data lines DL is an average of the pixel data of the pixels PIX corresponding to each data line DL on the first and the second scan lines SL. The pixel data can be a gray scale value or a brightness value of the pixel PIX. When the average of the pixel data is calculated, the pixel data corresponding to the pixels PIX participating the average calculation are all converted into the gray scale values or the brightness values for calculation.

Similarly, the driving method of the present embodiment can also be used in collaboration with the driving method of the embodiment of FIG. 7 to change a start position of sequentially enabling the scan lines SL in the unit of two scan lines SL during the scan period of the adjacent frames. FIG. 15 is a driving schematic diagram of a display panel 1500 according to an embodiment of the invention, and a sampling method thereof is similar to that of the embodiment of FIG. 14. A difference between the embodiment of FIG. 15 and the embodiment of FIG. 14 is that in the driving method of the display panel of FIG. 15, when the next frame update procedure is performed, it is started from the second scan line SL to sequentially enable the scan lines SL of the display panel 1500 in the unit of two scan lines. Similarly, before the scan lines SL are sequentially enabled from the second scan line SL in the unit of two scan lines, the first scan line SL on the display panel 1500 has to be first enabled to maintain integrity of the display frame.

In the aforementioned embodiments, although a situation that two scan lines SL are simultaneously driven is taken as an example to describe the driving methods of the display panels, the invention is not limited thereto, and more than two scan lines SL can be simultaneously driven. Moreover, when a start position for simultaneously driving a plurality of the scan lines SL is changed, it is not limited to the position of the second scan line SL as that described in the aforementioned embodiments, and a scan line SL behind the second scan line SL can also be taken as the start position for simultaneously driving the scan lines SL.

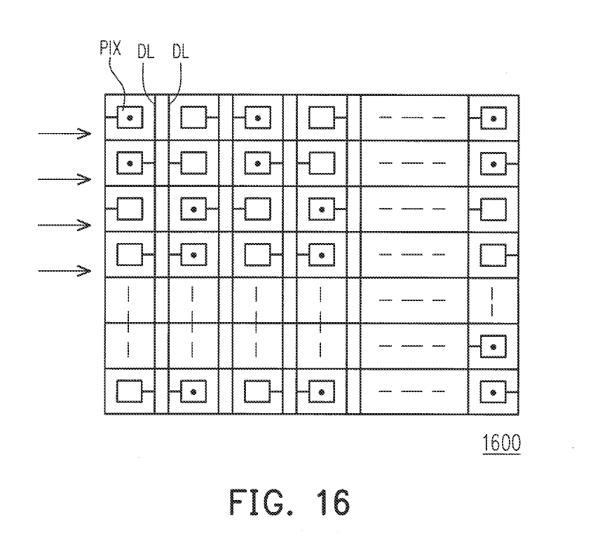

Moreover, the aforementioned driving methods can also be applied to a display panel of a 2D2G structure. For example, FIG. 16 is a driving schematic diagram of a display panel of a 2D2G structure according to an embodiment of the invention. Referring to FIG. 16, the driving method of the embodiment of FIG. 5 can be used to simultaneously drive four scan lines SL to reduce the time required for updating a frame. The pixel data sampling position is set to sample pixel data corresponding to odd pixels PIX on the first and the second scan lines SL and pixel data corresponding to even pixels PIX on the third and the fourth scan lines SL, so that the sampling positions of the display panel 1600 is similar to the chessboard-like sampling positions of the embodiment of FIG. 8, by which the evenness of the display frame is improved. When the four scan lines SL are simultaneously enabled, the pixel data received by the pixels PIX corresponding to the same data line DL on the first scan line SL and the third scan line SL are the same. Similarly, the pixel data received by the pixel PIX corresponding to the same data line DL on the second scan line SL is also the same to the pixel data received by the pixel PIX corresponding to the same data line DL on the fourth scan line SL. Deduced by analogy, the other driving methods of the aforementioned embodiments can also be applied to the display panel of the 2D2G structure, and those skilled in the art can deduce the implementations thereof according to the instructions of the above embodiment, so that details thereof are not repeated.

In summary, the time required for updating the display frame is shortened by simultaneously enabling a plurality of the scan lines, so that the liquid crystal has enough time for rotating to the required positions to avoid the motion blur phenomenon of the display panel. Moreover, the evenness and resolution of the display frame are enhanced in collaboration with different pixel data sampling positions, so as to achieve better viewing quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A driving method of a display panel, the display panel comprising a plurality of scan lines, a plurality of data lines and a plurality of pixels, and the driving method of the display panel comprising:
simultaneously enabling N scan lines, and delivering same pixel data to the pixels coupled to the enabled N scan lines through each of the data lines, wherein N is a positive integer greater than 1.

2. The driving method of the display panel as claimed in claim 1, further comprising:
simultaneously enabling N scan lines during each of a plurality of first scan periods, and delivering the same pixel data to the pixels coupled to the N scan lines through each of the data lines, so as to sequentially enable the scan lines to update a display frame of the display panel, wherein the pixel data delivered by odd data lines is obtained by sampling pixel data corresponding to odd pixels on odd scan lines, and the pixel data delivered by even data lines is obtained by sampling pixel data corresponding to even pixels on even scan lines; and
holding the display frame updated during the first scan periods in a first frame holding period.

3. The driving method of the display panel as claimed in claim 2, wherein after the first frame holding period, the driving method further comprises:
simultaneously enabling N scan lines during each of a plurality of second scan periods, and delivering the same pixel data to the pixels coupled to the N scan lines through each of the data lines, so as to sequentially enable the scan lines to update a display frame of the display panel, wherein the pixel data delivered by the odd data lines is obtained by sampling pixel data corresponding to the odd pixels on the even scan lines, and the pixel data delivered by the even data lines is obtained by sampling pixel data corresponding to the even pixels on the odd scan lines; and
holding the display frame updated during the second scan periods in a second frame holding period.

4. The driving method of the display panel as claimed in claim 3, wherein during the first scan periods, the scan lines are sequentially enabled from a first scan line in a unit of N scan lines, and during the second scan periods, the first scan line to a (P-1)^{th} scan line are first enabled, and then the remained scan lines are sequentially enabled from a p^{th} scan line in a unit of N scan lines, wherein P is a positive integer greater than 1.

5. The driving method of the display panel as claimed in claim 2, wherein the pixel data delivered by each of the data lines is a weighted average obtained by performing a weighted operation on the pixel data of the sampled pixels and the adjacent pixels thereof

6. The driving method of the display panel as claimed in claim 5, wherein the weighted operation is performed on gray scale values or brightness values of the pixel data.

7. The driving method of the display panel as claimed in claim 5, wherein the pixel data delivered by each of the data lines is a weighted average obtained by performing a weighted operation on the pixel data of the sampled pixels and four adjacent pixels thereof.

8. The driving method of the display panel as claimed in claim 5, wherein the pixel data delivered by each of the data lines is a weighted average obtained by performing a weighted operation on the pixel data of the sampled pixels and eight adjacent pixels thereof

9. The driving method of the display panel as claimed in claim 2, wherein after the first frame holding period, the driving method further comprises:
simultaneously enabling N scan lines during each of a plurality of second scan periods, and delivering the same pixel data to the pixels coupled to the N scan lines through each of the data lines, so as to sequentially enable the scan lines to update a display frame of the display panel, wherein the pixel data delivered by the odd data lines is obtained by sampling pixel data corresponding to the odd pixels on the odd scan lines, and the pixel data delivered by the even data lines is obtained by sampling pixel data corresponding to the even pixels on the even scan lines; and
holding the display frame updated during the second scan periods in a second frame holding period.

10. The driving method of the display panel as claimed in claim 9, wherein during the first scan periods, the scan lines are sequentially enabled from a first scan line in a unit of N scan lines, and during the second scan periods, the first scan line to a (P-1)^{th} scan line are first enabled, and then the remained scan lines are sequentially enabled from a p^{th} scanline in a unit of N scan lines, wherein P is a positive integer greater than 1.

11. The driving method of the display panel as claimed in claim 9, wherein after the second frame holding period, the driving method further comprises:
simultaneously enabling N scan lines during each of a plurality of third scan periods, and delivering the same pixel data to the pixels coupled to the N scan lines through each of the data lines, so as to sequentially enable the scan lines to update a display frame of the display panel, wherein the pixel data delivered by the odd data lines is obtained by sampling pixel data corresponding to the odd pixels on the even scan lines, and the pixel data delivered by the even data lines is obtained by sampling pixel data corresponding to the even pixels on the odd scan lines;
holding the display frame updated during the third scan periods in a third frame holding period;
simultaneously enabling N scan lines during each of a plurality of fourth scan periods after the third frame holding period, and delivering the same pixel data to the pixels coupled to the N scan lines through each of the data lines, so as to sequentially enable the scan lines to update a display frame of the display panel, wherein the pixel data delivered by the odd data lines is obtained by sampling pixel data corresponding to the odd pixels on the even scan lines, and the pixel data delivered by the even data lines is obtained by sampling pixel data corresponding to the even pixels on the odd scan lines; and
holding the display frame updated during the fourth scan periods in a fourth frame holding period.

12. The driving method of the display panel as claimed in claim 11, wherein during the third scan periods, the first scan line to a (P-1)^{th} scan line are first enabled, and then the remained scan lines are sequentially enabled from a p^{th} scan line in a unit of N scan lines, and during the fourth scan periods, the scan lines are sequentially enabled from the first scan line in a unit of N scan lines.

13. The driving method of the display panel as claimed in claim 1, further comprising:
simultaneously enabling N scan lines during each of a plurality of first scan periods, and delivering the same pixel data to the pixels coupled to the N scan lines through each of the data lines, so as to sequentially enable the scan lines to update a display frame of the display panel, wherein the pixel data delivered by each of the data lines is an average of the pixel data of the pixels corresponding to the same data line on the N enabled scan lines; and
holding the display frame updated during the first scan periods in a first frame holding period.

14. The driving method of the display panel as claimed in claim 13, wherein the average is an average of gray scale values or brightness values of the pixels.

15. The driving method of the display panel as claimed in claim 1, further comprising:
simultaneously enabling N scan lines during each of a plurality of first scan periods, and delivering the same pixel data to the pixels coupled to the N scan lines through each of the data lines, so as to sequentially enable the scan lines to update a display frame of the display panel, wherein during the first scan periods, the scan lines are sequentially enabled from a first scan line in a unit of N scan lines;
holding the display frame updated during the first scan periods in a first frame holding period;
simultaneously enabling N scan lines during each of a plurality of second scan periods, and delivering the same pixel data to the pixels coupled to the N scan lines through each of the data lines, so as to sequentially enable the scan lines to update a display frame of the display panel, wherein during the second scan periods, the first scan line to a (P-1)^{th} scan line are first enabled, and then the remained scan lines are sequentially enabled from a p^{th} scan line in a unit of N scan lines, wherein P is a positive integer greater than 1; and
holding the display frame updated during the second scan periods in a second frame holding period.

16. The driving method of the display panel as claimed in claim 1, further comprising:
simultaneously enabling N scan lines during each of a plurality of first scan periods, and delivering the same pixel data to the pixels coupled to the N scan lines through each of the data lines, so as to sequentially enable the scan lines to update a display frame of the display panel, wherein the pixel data delivered by odd data lines is obtained by sampling pixel data corresponding to odd pixels on odd scan lines, and the pixel data delivered by even data lines is obtained by sampling pixel data corresponding to even pixels on odd scan lines; and
holding the display frame updated during the first scan periods in a first frame holding period.

17. The driving method of the display panel as claimed in claim 1, further comprising:
simultaneously enabling N scan lines during each of a plurality of first scan periods, and delivering the same pixel data to the pixels coupled to the N scan lines through each of the data lines, so as to sequentially enable the scan lines to update a display frame of the display panel, wherein the pixel data delivered by odd data lines is obtained by sampling pixel data corresponding to odd pixels on even scan lines, and the pixel data delivered by even data lines is obtained by sampling pixel data corresponding to even pixels on even scan lines; and
holding the display frame updated during the first scan periods in a first frame holding period.
